(19) United States
(12) Patent Application Publication
(10) Pub. No.: US 2025/0235373 A1
(43) Pub. Date: Jul. 24, 2025

(54) Swinging massage device and its massager

(71) Applicant: Xiaoqiao Innovation (Dongguan) Health Technology Co., Ltd., Dongguan (CN)

(72) Inventor: Guohong Sheng, Ji'an (CN)

(21) Appl. No.: 18/421,037

(22) Filed: Jan. 24, 2024

(51) Int. Cl. A61H 19/00; A61H 23/02

(52) U.S. Cl. CPC A61H 19/44; A61H 19/34; A61H 23/0254

(57) ABSTRACT

The present invention discloses a swinging massage device and massager, which achieves a high-frequency reciprocating swinging and rotating motion through the transmission of the screw, gear, crank, and connecting rod. This transforms the working part from simple vibration to a smoother dynamic motion that can vibrate, swing, or rotate. Compared to traditional vibration and other motion products, it is more user-friendly and has a more linear dynamic motion according to user preferences.

### TECHNICAL FIELD

The present invention relates to the field of massagers, more specifically, to a swinging massage device and its massager.

### BACKGROUND TECHNOLOGY

Currently available massagers on the market combine simple single-point vibrations with massage sticks, which have various styles. However, the use of only single-point vibrations sometimes fails to provide users with a better sensory experience.

### SUMMARY OF THE INVENTION

The objective of the present invention is to provide a swinging massage device and its massager to solve the aforementioned problems.

The present invention achieves the above objectives through the following technical solutions:

A swinging massage device includes a casing with an opening. The casing is installed a motor, a screw, a gear, a crank, a connecting rod, and a tongue.

The output shaft of the motor is connected to the screw. The screw engages with the gear for transmission. One end of the gear is connected to the casing for rotation, and the other end is connected to the crank. The eccentric position of the crank is connected to one end of the connecting rod through a crank arm. The other end of the connecting rod is connected to the tongue. The tongue is assembled with the casing through a pivot shaft and extends out of the opening of the casing. The connecting rod moves back and forth as the crank rotates, driving the tongue to swing or tap (rotate).

As an important technical solution, the casing includes a first casing and a second casing. The first casing is snap-fitted with the second casing, and both the joint between the first casing and the second casing have notches, forming an opening for the tongue to extend.

As a preferred option, the tongue includes a tongue body, a pivot shaft sleeve, and a connecting part, which are integrally formed. The connecting part is connected to the connecting rod through a connecting pin, and the pivot shaft sleeve is rotatably connected to the pivot shaft. The tongue body extends outwardly from the opening of the casing.

As a preferred option, the gear is rotatably connected to the casing through bearings.

As a preferred option, the motor is a DC motor.

As a preferred option, the crank is integrally formed with the crank arm. The connecting rod is connected to the crank arm through a connecting pin, and the crank is connected to the gear through a fixing screw.

A massager includes the above-mentioned swinging massage device. It further includes a massage stick, which is assembled with the massage device through a silicone casing.

Furthermore, the casing of the massage stick is equipped with a battery and a control board, which is electrically connected to the motor and controlled by a switch.

The beneficial effect is that the massager in this application achieves high-frequency reciprocating swinging and rotating movements through the transmission of the screw, gear, crank, and connecting rod. This transforms the working part of the massager from simple vibration to a smoother combination of vibration and swinging or tapping movements. Compared to traditional vibration or other types of movements, this product is more user-friendly and linear in its motion.

### DESCRIPTION OF THE DRAWINGS

The following is a brief introduction to the drawings used in the description of the embodiment or prior art in order to more clearly illustrate the technical solutions of the embodiment or prior art in this invention. It is obvious that the drawings described below are only some embodiment of the present invention, and for ordinary skilled persons in the art, they can obtain other drawings based on these drawings without creative labor.

FIG. 1 is a three-dimensional view of the massager in this application;

FIG. 2 is a front view of the structure of the massager in this application;

FIG. 3 is an internal structural view of the massager and the massage device in this application;

FIG. 4 is a three-dimensional view of the massage device of the present invention;

FIG. 5 is a structural schematic view of the first casing of the massage device of the present invention;

FIG. 6 is a structural schematic view of the second casing of the massage device of the present invention;

FIG. 7 is an internal structural view of the massage device of the present invention;

FIG. 8 is a three-dimensional schematic view of the transmission structure of the massage device of the present invention;

FIG. 9 is another direction three-dimensional schematic view of the transmission structure of the massage device of the present invention;

FIG. 10 is a front view structural schematic of the tongue of the massage device of the present invention;

FIG. 11 is a three-dimensional structural schematic view of the tongue of the massage device of the present invention.

Figure annotations are as follows:

1. Massage device; 2. Massage stick; 201. Motor; 202. Screw; 203. Gear; 204. Bearing; 205. Crank; 205a. Crank arm; 206. Connecting rod; 207. Tongue; 207a. Tongue body; 207b. Pivot sleeve; 207c. Connection part; 208. Pivot; 3. Switch; 4. Control board; 5. Casing; 5a. First casing; 5b. Second casing.

### DETAILED DESCRIPTION

In order to make the objectives, technical solutions, and advantages of the present invention clearer, the technical solutions of the present invention will be described in detail below. It is obvious that the described embodiment is only part of the embodiment of the present invention, not all embodiment. Based on the embodiment of the present invention, all other embodiment obtained by those skilled in the art without any creative effort are within the scope of protection of the present invention.

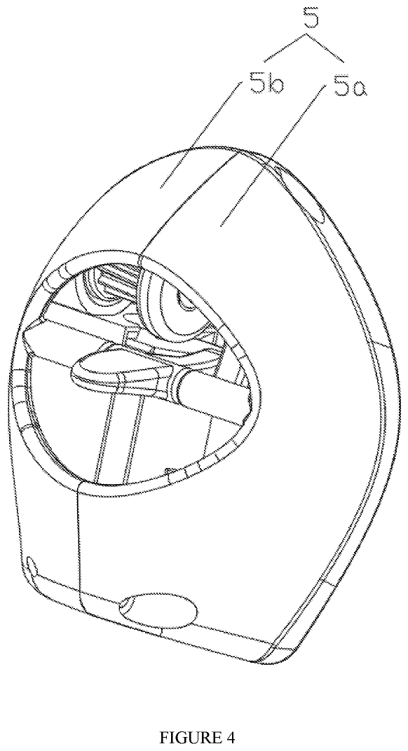

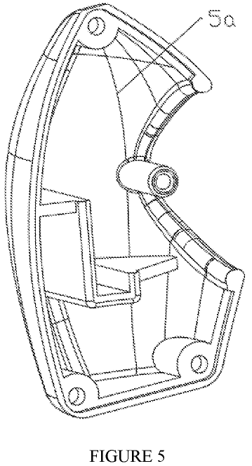

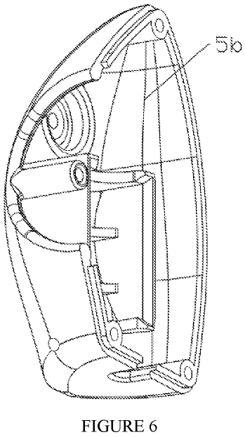

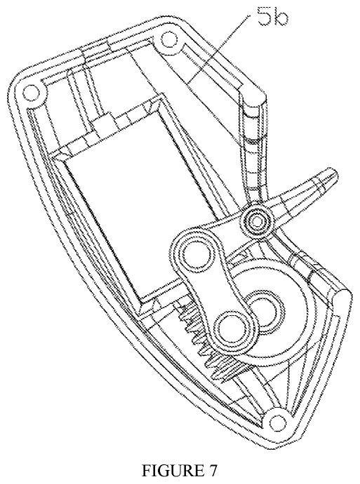

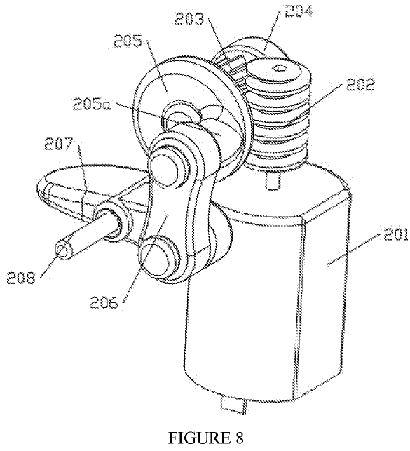

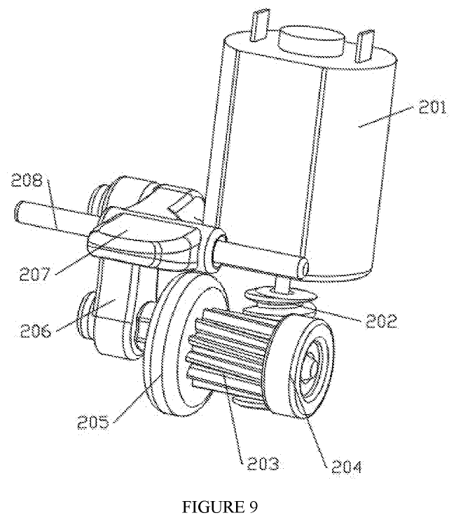

Referring to FIGS. 4 to 11, the present invention provides a swing-type massage device, including a casing 5, which has an opening. Inside the casing 5, there are installed a motor 201, a screw 202, a gear 203, a crank 205, a connecting rod 206, and a tongue 207. The output shaft of the motor 201 is connected to the screw 202, and a DC motor 201 is used as the motor 201. The screw 202 meshes with the gear 203, and one end of the gear 203 is rotatably connected to the casing 5, while the other end is connected to the crank 205. Specifically, the gear 203 is rotatably connected to the casing 5 via a bearing 204. The eccentric position of the crank 205 is connected to one end of the connecting rod 206 via a crank arm 205a, and the other end of the connecting rod 206 is connected to the tongue 207. The tongue 207 is assembled to the casing 5 via a pivot 208, and the tongue 207 extends out of the opening of the casing 5. Specifically, the motor 201 drives the screw 202 to rotate axially, thereby driving the gear 203 to rotate the crank 205. The connecting rod 206 connected to the crank arm 205a moves back and forth as the crank 205 rotates, and the tongue 207 connected to the connecting rod 206 through the pivot 208 moves left and right or up and down to increase the user's massage experience.

As one embodiment, the casing 5 includes a first casing 5a and a second casing 5b. The first casing 5a is engaged with the second casing 5b, and both the junctions of the first casing 5a and the second casing 5b are provided with notches. After engagement, an opening is formed with the protrusion of tongue 207, which facilitates the assembly and disassembly of the swing-type massage device 1.

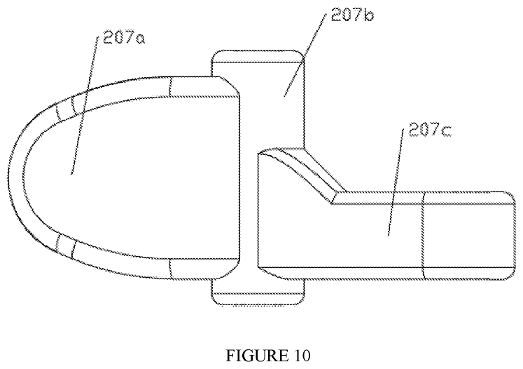

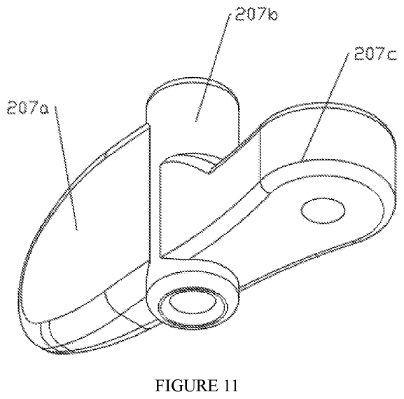

As a preferred embodiment, as shown in FIGS. 10 and 11, the tongue 207 includes a tongue body 207a, a shaft sleeve 207b, and a connecting part 207c. The tongue body 207a, the shaft sleeve 207b, and the connecting part 207c are integrally formed. The connecting part 207c is connected to the connecting rod 206 by a connecting pin. Optionally, the shaft sleeve 207b and the shaft 208 are rotary connection. The tongue body 207a extends out of the opening of the casing 5 in a tongue shape. The tongue body 207a can swing or rotate left and right outside the casing 5 through the driving of the connecting rod 206, thereby stimulating the massage area.

As a preferred embodiment, the crank 205 is integrally formed with the crank arm 205a. The connecting rod 206 is connected to the crank arm 205a by a connecting pin. The crank 205 is connected to the gear 203 by a fixing screw.

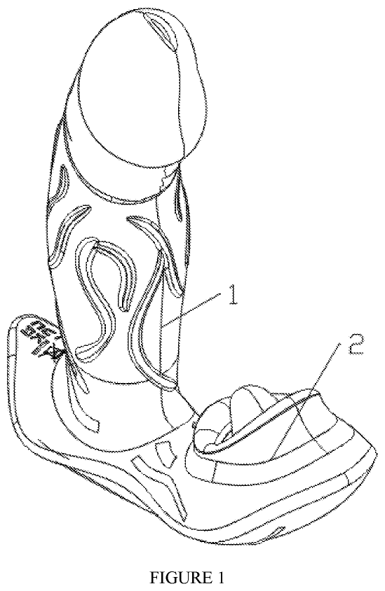

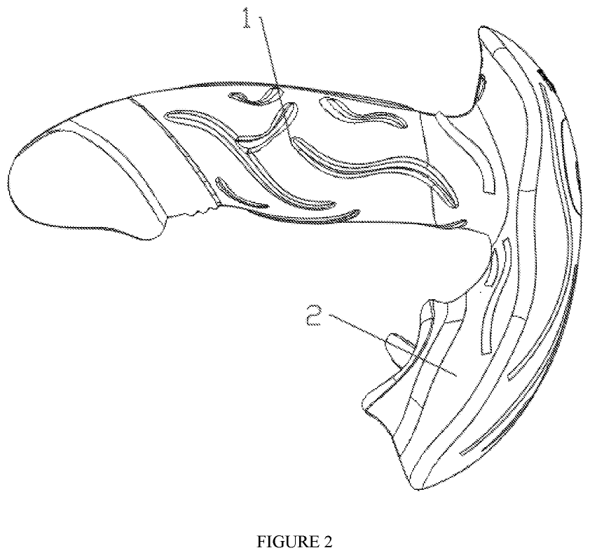

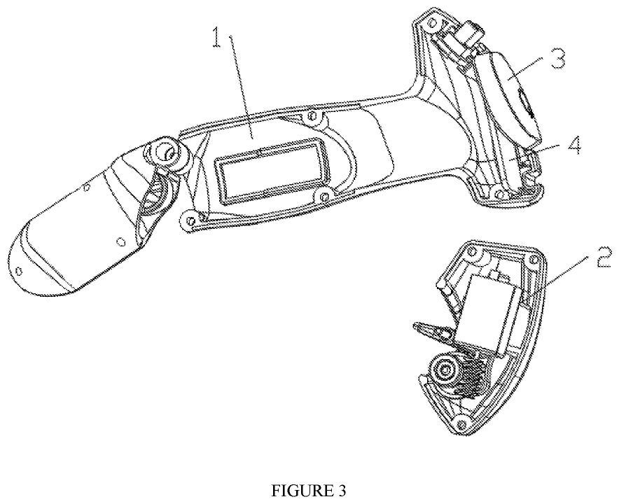

As shown in FIGS. 1-3, a massager includes the aforementioned swing-type massage device and a massage stick 2. The massage stick 2 is assembled with the massage device 1 through a silicone casing and has a simulated male reproductive organ shape. The silicone casing integrates the massage stick 2 with the swing-type massage device 1 and can be used together.

Furthermore, the casing of the massage stick 2 is equipped with a battery and a control board 4. The control board 4 is electrically connected to the motor 201 and controlled by a switch 3. The switch 3 controls the operation of the motor 201, and the battery is rechargeable.

The present massage device achieves high-frequency reciprocating swinging and rotating motion through the transmission of the screw 202, gear 203, crank 205, and connecting rod 206. This transforms the working part of the massager from simple vibration to a smoother vibrating, swinging, or rotating mode. Compared to traditional vibration and other motion products, it is more user-friendly and linear, providing a better massage experience for users. Moreover, the massage device 1 and the massager can be applied to female private massage and other parts of the body requiring massage.

The above description is only one specific embodiment of the present invention. However, the scope of protection of the present invention is not limited to this. Any person skilled in the art can easily conceive of changes or substitutions within the technical scope disclosed in the present invention, which should be covered by the scope of protection of the present invention as defined by the claims.

1. A swinging massage device, characterized by comprising a casing with an opening, wherein the casing is internally installed with a motor, a screw, a gear, a crank, a connecting rod, and a tongue;
the output shaft of the motor is connected to the screw, which engages with the gear for transmission;
one end of the gear is connected to the casing for rotation, while the other end is connected to the crank;
the eccentric position of the crank is connected to one end of the connecting rod through a crank arm;
the other end of the connecting rod is connected to the tongue, which is assembled with the casing through a pivot and extends outside the opening of the casing;
the connecting rod moves back and forth with the rotation of the crank, driving the tongue to swing or rotate back and forth.

2. According to claim 1, a swinging massage device, characterized in that: the casing comprises a first casing and a second casing, the first casing is snap-fitted with the second casing, and both the first and second casings have notches at their junction to form an opening for the tongue to extend out.

3. According to claim 1, a swinging massage device, characterized in that: the tongue comprises a tongue body, a pivot sleeve, and a connecting part, which are integrally formed;
wherein, the connecting part is connected to the connecting rod via a connecting pin, the pivot sleeve and the pivot are rotary connection, and the tongue body extends outward from the opening of the casing in a tongue shape.

4. According to claim 2, a swinging massage device, characterized in that: the tongue comprises a tongue body, a pivot sleeve, and a connecting part, which are integrally formed;
wherein, the connecting part is connected to the connecting rod via a connecting pin, the pivot sleeve and the pivot are rotary connection, and the tongue body extends outward from the opening of the casing in a tongue shape.

5. According to claim 1, a swinging massage device, characterized in that: the gear is rotationally connected with the housing through a bearing.

6. According to claim 1, a swinging massage device, characterized in that: the motor adopts a DC motor.

7. According to claim 1, a swinging massage device, characterized in that: the crank is integrally formed with the crank arm, the connecting rod is connected to the crank arm via a connecting pin, and the crank is connected to the gear through a fixing screw.

8. A massager, characterized in that: it includes any one of the swinging massage devices as claimed in claim 1; it further includes a massage stick, which is assembled with the massage device through a silicone casing.

9. A massager, characterized in that: it includes any one of the swinging massage devices as claimed in claim 2; it further includes a massage stick, which is assembled with the massage device through a silicone casing.

10. A massager, characterized in that: it includes any one of the swinging massage devices as claimed in claim 3; it further includes a massage stick, which is assembled with the massage device through a silicone casing.

11. A massager, characterized in that: it includes any one of the swinging massage devices as claimed in claim 4; it further includes a massage stick, which is assembled with the massage device through a silicone casing.

12. A massager, characterized in that: it includes any one of the swinging massage devices as claimed in claim 5; it further includes a massage stick, which is assembled with the massage device through a silicone casing.

13. A massager, characterized in that: it includes any one of the swinging massage devices as claimed in claim 6; it further includes a massage stick, which is assembled with the massage device through a silicone casing.

14. A massager, characterized in that: it includes any one of the swinging massage devices as claimed in claim 7; it further includes a massage stick, which is assembled with the massage device through a silicone casing.

15. According to claim 8, a swinging massage device, characterized in that: the casing of the massage stick is equipped with a battery and a control board, which is electrically connected to the motor and controlled by a switch.

16. According to claim 9, a swinging massage device, characterized in that: the casing of the massage stick is equipped with a battery and a control board, which is electrically connected to the motor and controlled by a switch.

17. According to claim 10, a swinging massage device, characterized in that: the casing of the massage stick is equipped with a battery and a control board, which is electrically connected to the motor and controlled by a switch.

18. According to claim 11, a swinging massage device, characterized in that: the casing of the massage stick is equipped with a battery and a control board, which is electrically connected to the motor and controlled by a switch.

19. According to claim 12, a swinging massage device, characterized in that: the casing of the massage stick is equipped with a battery and a control board, which is electrically connected to the motor and controlled by a switch.

20. According to claim 13, a swinging massage device, characterized in that: the casing of the massage stick is equipped with a battery and a control board, which is electrically connected to the motor and controlled by a switch.
